(19) United States
(12) Patent Application Publication
(10) Pub. No.: US 2008/0208852 A1
(43) Pub. Date: Aug. 28, 2008

(54) Editable user interests profile

(75) Inventors: Shyam Kuttikkad, Union City, CA (US); Anand Madhavan, Milpitas, CA (US); Mohit Vora, Mountain View, CA (US); Mike Clothier, Moraga, CA (US); Hongche Liu, Fremont, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc.

(21) Appl. No.: 11/710,879

(22) Filed: Feb. 26, 2007

(51) Int. Cl. G06F 17/30

(52) U.S. Cl. 707/6

(57) ABSTRACT

A method for an online information system includes tracking user interactions with the online information system, storing profile information for the user based on the user interactions, and providing user access to modify the user's profile information. This system improves confidence in system for users who are reluctant to have their online activity tracked by the system operator. The user has access to all information that the system operator has for the user, and can edit or correct that information.

### BACKGROUND

The present application relates generally to database systems. More particularly, the present invention relates to an editable user interests profile for such a database system.

The availability of powerful tools for developing and distributing Internet content has led to an increase in information, products, and services offered through the Internet, as well as a dramatic growth in the number and types of consumers using the Internet. To help users find their way through this immense volume of information, online service providers provide recommendations to the users. Such recommendations can be for products which match those which a user is searching for, or for products or services which are related to those which the user is searching for, or for other information that may be useful to the user. Further, such recommendations or other information provided by the online service provider can be based on user interactions and activities with one or more web sites.

In order to make suitable recommendations or expose the user to helpful information, the online service providers must track user behavior on their networks. This can be done explicitly by inviting users to register with the online service system so that identification information is obtained from the user. Alternatively, this can be done implicitly by tracking users' actions with their web browsers. Subsequently, user searches, clicks, page views, etc., are monitored and stored and processed. For example, statistical processing, collaborative filtering and data mining techniques may be used on behavioral information received from users. This results in “knowledge” of the online service provider about the user. This knowledge is continually supplemented and refined as the user's behavior is monitored. From this information, a profile of the user's interests can be developed, user recommendations can be made and online products and services can be developed and enhanced.

Most people are comfortable with the idea that their online behavior is being tracked and may be used commercially. This is generally true, for example, when the user's information is used to make recommendations for the user's benefit, and the recommendations are not unduly intrusive.

For many such users, such a recommendation system is a great asset and they would like additional ways to make use of or interact with such a system. Many users highly value the service and desire to refine or tailor the recommendation system. A user may desire to have a way to know what the online service provider knows about the user so that the recommendations made to the user are better targeted. Further, the user may like to delete all of what the online service provider knows about the user from past behavior and start afresh. Further, some users would like to get an automatic social networking/content generation by the online service provider based on what the online service provider knows about the user and a way to refine this. For these users, the perceived benefit outweighs any possible negative implications.

However, some members of the public have become uncomfortable with the notion that their online activities are being actively monitored and used for certain purposes. While publicly known purposes and uses are benign and are generally commercial in nature, there is a concern about hidden or secret purposes for tracking user behavior as well as possible secret usages of tracked behavior information. There are concerns about confidentiality of information which a user actively provides or which can be determined from monitoring online behavior. Also, there is a concern that personal information will be shared with commercial or governmental entities without user approval or knowledge. As a result, some users are opting out of registration and behavior tracking or even limiting their online usage.

This opt-out phenomenon poses problems for online service providers. First, they lose real and potential customers for their services. Second, they lose potential revenue from advertisers who would like to use the users' behavior information to make product and service recommendations to the users. Third, the online service provider and its affiliates and advertisers never obtain the opting-out users' information which prevents them from developing new products and markets to match user tastes or interests.

Further, for users, conventional recommendation systems fail to capitalize on the value of exposing the users' interests to the users themselves. Without this ability, the users lack the opportunity to know what the online service provider knows about the user or to manage or tailor this information.

Accordingly, there is a need for a system and method to overcome these and other problems while providing an additional service to the users, online service providers, and their affiliates and advertisers.

### BRIEF SUMMARY

By way of introduction only, the present disclosure provides a method for an online information system. The method includes monitoring user interactions with the online information system, storing profile information for the user based on the user interactions, and providing user access to modify and define the user's profile information. This system improves confidence in system for users who are reluctant to have their online activity tracked by the system operator. The user has access to most or all information that the system operator has for the user, and can edit or correct that information.

The foregoing discussion of the preferred embodiments has been provided only by way of introduction. Nothing in this section should be taken as a limitation on the following claims, which define the scope of the invention.

### BRIEF DESCRIPTION OF THE DRAWINGS

FIG. 1 shows an online information system; and

FIGS. 2-4 are screen shots of one embodiment of a user interface for managing an editable interests profile on the online information system of FIG. 1.

### DETAILED DESCRIPTION OF THE DRAWINGS AND THE PRESENTLY PREFERRED EMBODIMENTS

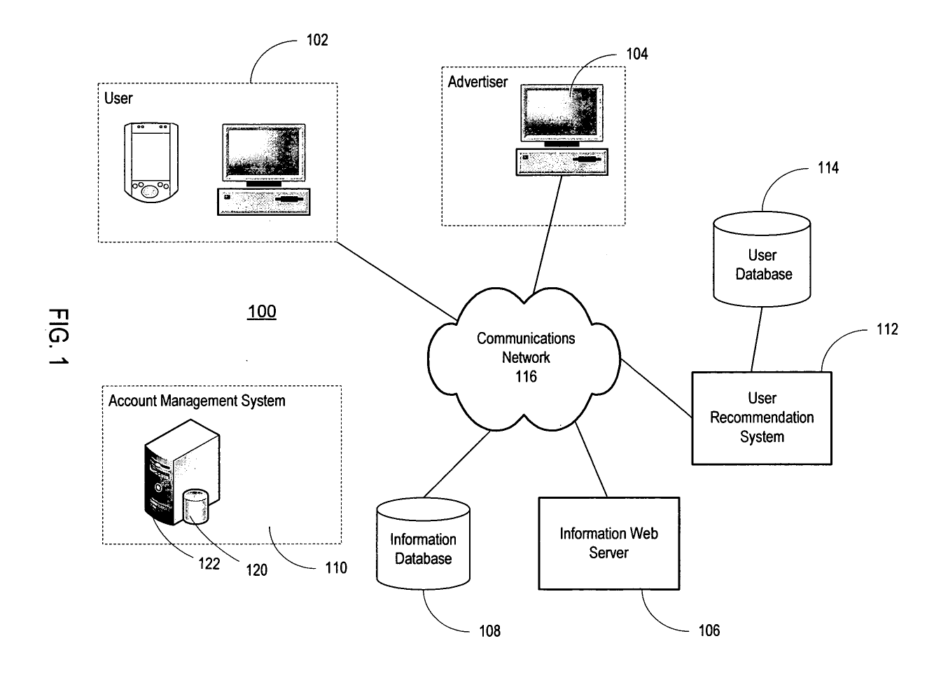

FIG. 1 shows an online information system 100. The online information system 100 is particularly adapted to providing information and recommendations to an online user. The online information system 100 includes a user client system 102, an advertiser client system 104, an information web server 106, an information database 108, an account management system 110, a user recommendation system 112 and a user database 114. Components of the system communicate data and information over a communications network 116. One example of an online information system is the system operated by Yahoo! Inc., on the World Wide Web at yahoo.com. Other examples include information providers affiliated with such an online system, such as advertisers or other information providers that provide to users information originating at a system such as the system operated by Yahoo! Inc.

The user client system 102 may access the online information system 100 via the communications network 116 to search for or browse through and obtain content. For example a user of the user client system 102 may submit a query via the communications network 116 to the information web server 106, which may be implemented on a server or other network enabled system. The user recommendation system 112 monitors information about user interests and makes recommendations to the user at the user client system 102. An advertiser using the advertiser client system 104 submits advertisements and content to the user recommendation system 112 which may be included with the recommendations made to the user client system 102. Advertisers can book ad campaigns targeted at aggregate user profiles. It will be appreciated that the components of the online information system 100 may be separate, may be supported on a single server or other network enabled system, or may be supported by any combination of servers or network enabled systems.

The communications network 116 may be any private or public communications network or combination of networks. The communications network 116 may be configured to couple one computing device, such as a server, system, database, or other network enabled device, to another device to enable communication of data between computing devices. The communications network 116 may generally be enabled to employ any form of machine-readable media for communicating information from one computing device to another. The communications network 116 may include one or more of a wireless network, a wired network, a local area network (LAN), a wide area network (WAN), a direct connection such as through a Universal Serial Bus (USB) port, and the like, and may include the set of interconnected networks that make up the Internet. The communications network 116 includes any communication method by which information may travel between computing devices.

The user client system 102 connects to the information web server 106 and the user recommendation system 112 via the communications network 116 using a standard browser application. A browser-based implementation allows system features to be accessible regardless of the underlying platform of the user client system 102. For example, the user client system 102 may be a desktop, laptop, handheld computer, cell phone, mobile messaging device, network enabled television, digital video recorder, such as a digital video recorder, automobile, or other network enabled user client system 102, which may use a variety of hardware and/or software packages. The user client system 102 may connect to the information web server 106 using a stand-alone application which may be platform-dependent or platform-independent. Other methods may be used to implement the user client system 102.

The advertiser client system 104 may be used by network information providers such as advertising web site promoters or owners having advertiser web pages. Advertisers may maintain advertiser accounts on the account management system for providing advertisements to users on the system. Advertisements may include banner advertisements, bidded advertisements or any other form of advertisements. These advertising web site promoters, or advertisers, may wish to access the advertiser account information residing on account management system 110. In one example, an advertising web site promoter may, through the advertiser account residing on the account management system 110, participate in a competitive bidding process with other advertisers to place information before users based on expressed user interests. An advertiser may bid on any number of search terms relevant to the content of the advertiser's web site. One example of such an online search engine system is disclosed in U.S. Pat. No. 6,269,361 entitled “System and Method for Influencing a Position on a Search Result List Generated by a Computer Network Search Engine” and assigned to Overture Services, Inc. In another example, an advertiser may specify banner advertisements to be placed on web pages sent to users accessing information on the system.

The information web server 106 implements a search engine. The information web server 106 permits network users, upon navigating to a uniform resource locator (URL) associated with the information web server 106 or other related site, to type keyword queries to identify pages of interest among the millions of pages available on the World Wide Web. The information web server 106 generates a search result list that may includes, at least in part, sponsored search listings obtained from and formatted by information in the account management system 110. The information web server 106 transmits the search result list to the network user for display on the browser running on the user client system 102. Upon selection by the user, as by clicking a hyperlink of the selected search listing, value is transferred from the account of the advertiser associated with the selected search listing to the online service provider who operates the online information system 100.

The account management system 110 includes computer storage medium 120 and a processing system 122. A database is stored on the storage medium 120 of the account management system 110. The database contains account information. The processing system 122 may be accessed by information providers operating an advertiser client system 104.

The user recommendation system 112 monitors information about user interests, maintains and updates a user interest profile, and makes recommendations to the user at the user client system 102. The user recommendation system 112 may make recommendations using any suitable algorithm or process. In general, though, the recommendations are based on contents of the user profile.

Further, the user recommendation system 112 monitors interactions by the user with the online information system 100. The user recommendation system 112 monitors interactions such as searches, content and ad views and clicks, forms filled, usage of services, etc., submitted to the information web server 106 and content selections made by the user. Based on these interactions, the user recommendation system 112 populates the user profile for the user.

Subsequently, when providing web pages of information to the user, the user recommendation system 112 makes selections of additional information to provide using the user profile. The selections of additional information may be included in a list of search results in response to a specific request from the user. Alternatively, the selections of additional information may be included on the web page but separate from the search results, such as a banner ad, text or graphical ads, service recommendations, content recommendations, email marketing campaigns, etc. The selections of additional information may be any other information appropriate for the user as determined by the contents of the user's profile.

The user's profile is stored in the user database 114. The user database 114 includes persistent memory for storing a wide variety of information about users. The user database 114 is in communication with the user recommendation system 112. The user database 114 in one example stores as a user profile some indication of a user's identity and further information about the user's interests. The information about the user's interests may be obtained by the user recommendation system 112 during monitoring of user behavior on the online information system 100. The user profile may be organized in any suitable manner. For example, the user profile may include a set of categories in which the user has, by his implicit or explicit behavior, expressed an interest. The profile may be stored in the database in any suitable manner, such as a vector of data having a predetermined meaning. The vector of data is written and read by the user recommendation system 112 accessing the user database 114.

The user recommendation system 112 develops a profile for the user based on identification information for the user and user behavior on the online information system 100. The user recommendation system 112 may obtain user identification information in any manner. One way of identifying a user is to invite the user to register with the online information system 100. If the user accepts the invitation, the user provides identifying information such as name, address and online user name. The system maintains this information for future review and updating by the user. Further, the user may provide demographic information such as gender, age and income. All the provided information is stored by the user recommendation system 112 in the user database 114 as part of the user profile and is associated with identification information for the user, such as an online user name.

Thus, the user recommendation system 112 may store information for identifying the user on the user's computer. In one example, the user recommendation system 112 stores one or more text files called cookies on the user client device 102. When a user of the user client device 112 accesses the online information system 100, the cookie is retrieved and information contained in the cookie, such as identification information for the user, is transmitted with an access request. The identification information in the access request is read by the user recommendation system 112 and used to update the user's profile in the user database 114.

In one embodiment, users may or must log in to the online information system. This may be done in any suitable manner, such as by providing an online user name and password. Once the user is logged in, the system begins logging the user's behavior, monitoring user interaction and storing information about the interaction. The information about the user's interaction is uniquely stored in association with the user's identification information. In this manner, the information about the user's behavior is not mixed with behavior information for other users, even if other users make use of the same device. Any other means or method of uniquely associating a user's identification with his behavioral information and validating that information may be used.

In another embodiment, an anonymous user profile may be maintained for an anonymous user, such as one who has not logged in but who makes use of a device to access the system. In the case of the anonymous user profile, this profile may not be accessed for viewing or editing. Only validated user behavior information may be accessed, view or edited.

The present embodiments permit a user to view and modify their interest information stored in the user's profile on the user database 114. The user's interests are tracked by the online information system 100 by monitoring the user's behavior and the interaction with the online information system 100. This behavior includes, for example, searches submitted to the online information system 100, clicks on hyperlinks presented on pages sent to the user, page views including time spent viewing a page and mouse and keyboard activity transmitted to the web server. In response to the detected user behavior, the online information system 100 populates a user profile for the user with information about the user's interests as expressed by the user's behavior. If a user profile already exists, the online information system 100 updates the user profile.

In one exemplary embodiment, the user profile includes a list of categories of products, services and topics. For example, the topics may be arranged hierarchically as topics and subtopics, such as the topic “automobile” with subtopics “automobile-sedan” and “automobile-coupe.” In this example, if a user searches for information about a Ford Motor Company product, his user profile will be automatically updated by adding the category “automobile.” If he is presented information about two-door Ford automobiles and four door Ford automobiles, and follows both links in his searching, this behavior will be detected by the online information system 100 and the user profile will be updated to add categories of “automobile-sedan” and “automobile-coupe.” The categories are defined in this example by the operator of the online information system 100, but may be organized in any particular manner.

In addition to the category arrangement of the user profiles in the user database 114, in this example, the user profile includes a rating or score within each category. The category reflects an interest of the user. The rating reflects a relative strength of the user's interest. For example, on a 1 to 100 scale, a rating of 1 would indicate only a passing or occasional interest in the topic, while a rating of 100 would indicate a close and avid interest in the topic. The ratings may be adjusted according to time. For example, a user's frequent searches for information about automobiles might produce a high rating. After the user has purchased an automobile and the searches stop or subside, the rating will be reduced over time, declining from a high value to a low value over several weeks or months.

The user profile information may be stored in any suitable manner in the user database 114. In one example, the user profile is stored as a vector of data, each component of the vector having a defined meaning. Other storage arrangements may be used as well.

In accordance with the present exemplary embodiment, a user may access the user recommendation system 112 and view and modify information contained in his user profile. This can be done, for example, by the user accessing a particular web page of the online information system 100. The particular web page may access a user interest editing module of the user recommendation system 112. The module may be, for example, a set of program instructions which are operated in conjunction with the user recommendation system 112. For security, the user may be asked at an initial page of the module to log in by entering a username and a password.

Subsequently, the user is presented with one or more web pages showing information about user interests or other aspects of the user's profile. The information may be displayed on the web page in any convenient format, such as in a grid for viewing by the user in the case where the information includes user interest categories. The user can view and modify the user profile information including the categories. In one embodiment, a numerical value corresponding to a score and related to relative user interest is associated with each category. The actual scores for these categories may or may not be editable by the user. In one embodiment, the system may show the user an abstraction of these scores into enumerated values such as “high/medium/low” and the user may be able to adjust these values.

In one embodiment, the user can clear the entire list of user interests stored for the user, such as by clicking a single button on the displayed web page. This will have the effect of clearing the entire interest vector so that no interest is stored in the vector defining the user profile. The user will start gaining interest and strengths (increased score values) for these interests based on the future activities by the user.

Alternatively, the user may selectively clear some interests on the web page. For example, the web page presented to the user includes a list of interests and associated check boxes. In this case, the user's categories are all checked on the displayed web page, meaning that his profile includes each checked interest. The user is limited to un-checking the checked boxes. He may not check additional boxes to manually create his own interests. This feature limits editing the user's interests to actual manual, human interaction with the web page. This prevents automatic devices such as robot code from improperly adjusting the user's interests.

In a further alternative, the user may selectively clear some interests of the user profile. By checking or un-checking a box corresponding the user interest on the displayed web page, the user indicates that this interest should be removed from his profile. By performing the opposite action, the user indicates that a displayed interest should be added to his profile. While this alternative is susceptible to the potential abuse mentioned above, it provides maximum flexibility for the user to control his profile. In an arrangement where a goal is to get the user comfortable with the information about him tracked by the online information system 100, this flexibility and transparency may be preferred.

In an additional feature, users accessing their user profile can choose to configure the effect of these changes according to one or more rules. In a first rule, that may be described as a “decree,” the user's designation of interests upon accessing the user recommendation system 112 is final. No future changes are possible on some or all categories selected, including manual changes by the user accessing the user interest editing module or by automatic update by the user recommendation system 112.

In a second rule, which may be described as a “demand,” the changes made by the user remain in effect and no automatic tracking is allowed to change the interest designation, until the user manually changes the designation at some future time by accessing the site.

In a third rule, which may be described as “suggestion,” changes are made by the user for suggestion purpose only. The changes take effect immediately but can be updated later either by automatic tracking by the user recommendation system 112 or manually by the user accessing the web site of the user interest editing module.

In yet an additional feature, one or more pages may be accessed by the user to simulate events on the online information system 100. In this manner, the user can dynamically see the effect of changing his interests in his user profile. When accessed by a user, these pages automatically display content based on the user's interests as currently stored in the user profile.

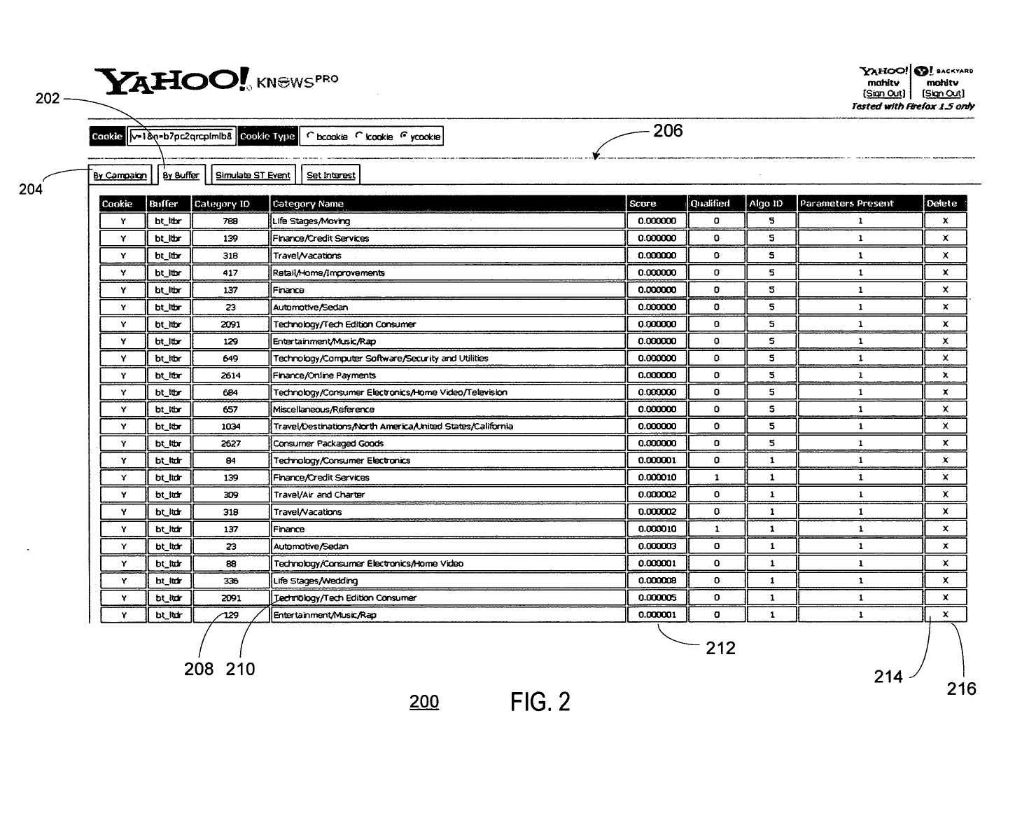

FIG. 2 shows an exemplary user interface 200 allowing a user to manually edit the interests in his user profile of an online information system. In one embodiment, the user interface 200 is displayed on a web page served to a user at a user client device 102 upon login access to the online information system 100 by the user. The user interface includes a buffer view selector 202, a campaign view selector 204 and a list 206 of interest categories.

The buffer view selector 202 includes a hyperlink. When selected by clicking with a mouse or other device, the buffer view of FIG. 2 is provided on a web page sent to the user. The buffer view shows the list of interest categories for the user. The list is arranged in any convenient order. The list 206 is populated using information in the user's profile, stored in the user database 114. The campaign view selector 204 includes a hyperlink that may be selected to switch to a web page showing the user interest categories organized by campaign. In alternative embodiments, the user may be presented with abstracted information showing only the interests that the online information provider has identified for the user.

The list 206 shows all interests the online information system 100 has determined for the user based on his behavior on the system 100. A single page is shown in FIG. 2, but the user's interests may spread over several pages. The list 206 is arranged in several columns. In the example of FIG. 2, one column 208 shows a category identifier and another column 210 shows a category name for each interest in the list. A third column shows a score or rating for the user in that category. In some embodiments, the ability for a user to see the user's score or other information displayed in FIG. 2 will not be viewable or accessible. The internal algorithm for determining score may be kept confidential by the operator of the online information system 100.

The list 206 further includes a column 214 for a user to delete an interest category from the list 206. In the illustrated embodiment, the column 214 includes a set of delete buttons 216 which represent hyperlinks. Upon clicking a delete button 216, a command is sent from the user client device to the user recommendation system 112 and the category is deleted from the user's user profile stored in the user database 114. In another embodiment, user is presented with a list of interests such as the interest categories of FIG. 2, along with an adjacent check box. The user may interact with the web page to check (or un-check) the check boxes associated with the categories. When complete, the user can click an on-screen button labeled “finished” or similar, and the command to remove the identified categories is sent to the user recommendation system 112. Other embodiments may omit the details shown in FIG. 2 in favor of a display which is simpler or more straightforward for use by the user. Further, the features displayed to the user, such as the buffer or algorithm identifier, may be variably displayed depending on the user or the context.

In another embodiment, users may view their interests and see a generic interest value, such as one of high, medium and low. The actual numerical value calculated by the system may be mapped to these generic levels using any suitable technique. Further, the user may be given the option to manually edit the assigned interest level. Thus, upon viewing a stored interest level of “low” for a particular topic or category, the user may change the generic value to “high” or “medium” depending upon his actual interest level.

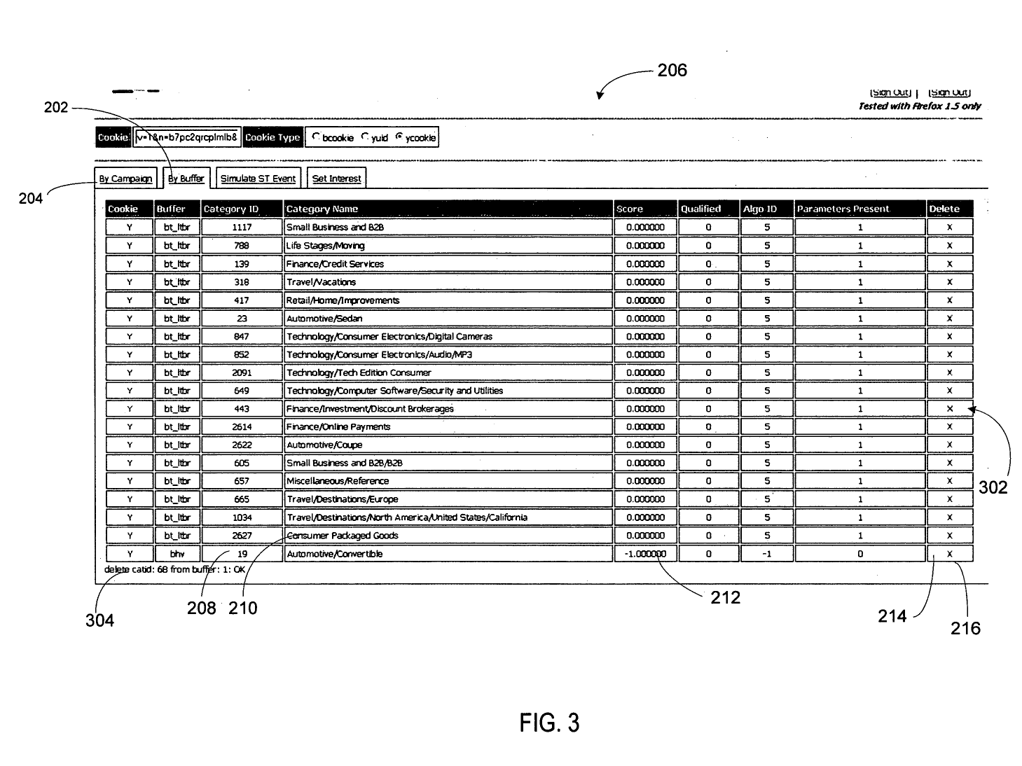

FIG. 3 illustrates the user interface of FIG. 2 after selection of a category to delete. In FIG. 3, the user interest with category identification 443, entitled Finance/Investment/Discount brokerages, has been designated for deletion by checking its check box 302. The check box 302 has been changed in appearance and a confirming message 304 is displayed at the bottom of the web page.

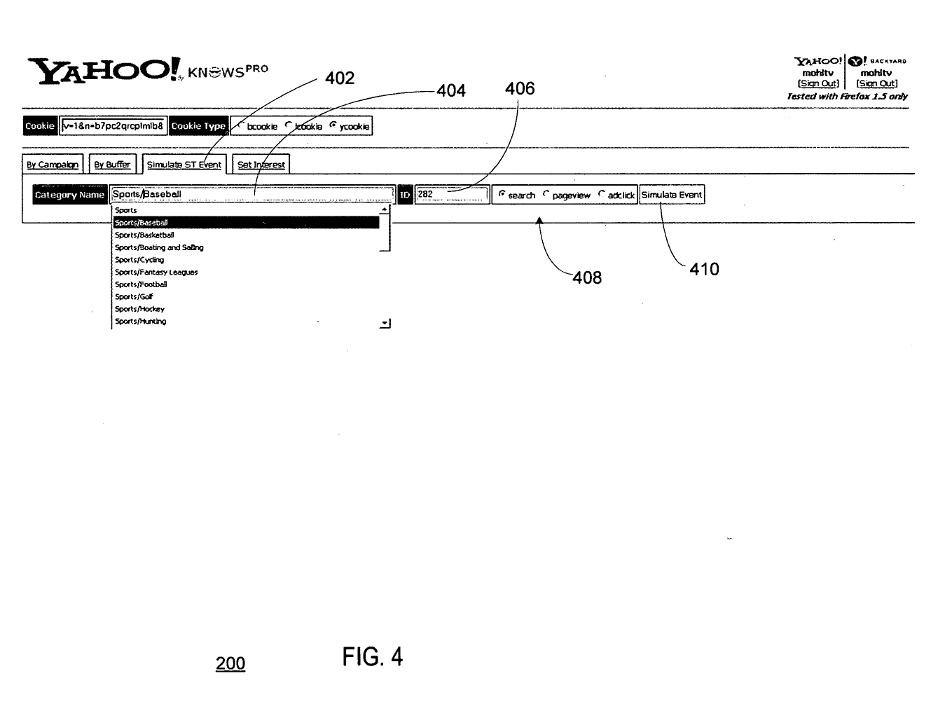

FIG. 4 illustrates use of the user interface 200 by a user to allow a user to select his interests and then to simulate events in order to confirm that the changes made to the user profile by the user have taken effect. In one embodiment, the features provided by this user interface may not be made available to users, or may be made available on only a limited or selected basis. The user interface 200 in this view includes a navigation tab 402, a first pop up menu 404, a second pop up menu 406, a simulation selector 408 and a simulate event button 410.

This exemplary web page may be accessed by selecting the navigation tab 402 labeled Simulate ST Event. The user interface 200 includes a first pop up menu 404 to select a category by name and a second pop up menu 406 to select a category by catalog identifier. The user can actuate the pop up menus 406, 408 to set any number of interests.

The simulation selector 408 includes several options for simulation types to run. The possible types in this example include a simulated search, a simulated page view and a simulated ad click. The simulation desired may be selected by ticking one of the dots by the three choices. Once the desired simulation has been selected, the simulation may be initiated by clicking the simulate event button 410. After the simulation is run, the user may return to the buffer view of FIG. 2 to confirm that the anticipated effect on the user's interests has been achieved. Also, in some embodiments, rather than including the detailed options illustrated in FIG. 4, instead some abstracted set of options may be provided to the user. This may be done to simplify operation for the user or to limit user awareness of some details of operation of the system.

From the foregoing, it can be seen that the present disclosure provides methods and apparatus to allow a user to edit his user profile in an online information system. The user profile is developed by automatically monitoring user behavior on the online information system. The user profile includes information about interests of the user. Based on these interests, information is presented to the user on web pages sent to the user. The user may manually access the system and change his interest information in his user profile. The profile information by include interest categories, or it could be much more like the demo, location, etc. The display of these profiles can be as specific as a category or demo level or as generic as a content module based on these profiles, which the user can edit or modify or delete.

The disclosed system and method provide substantial benefit to the user, the operator of the online information system and its information providers. For users, their confidence and trust in the system is enhanced. The ability to access their user profile is a reassurance that they can see information that the system operator maintains about them and creates a sense of openness and confidence in the system. Further, users are able to modify or refine what the system knows to get better content or ads. For the system operator, fewer users are likely to opt out of having their online activities tracked, meaning that the operator can learn more about the users and tailor subsequent offerings to those users' tastes. For the advertiser, there is an increased confidence in the information about the users of the online information system since more users are participating and are updating their interest information.

It is therefore intended that the foregoing detailed description be regarded as illustrative rather than limiting, and that it be understood that it is the following claims, including all equivalents, that are intended to define the spirit and scope of this invention.

1. A method for an online information system, the method comprising:
tracking user interactions with the online information system;
storing profile information for the user based on the user interactions; and
providing user access to modify profile information.

2. The method of claim 1 wherein tracking comprises
tracking search queries submitted by the user;
tracking clickthroughs of the user; and
tracking page views of the user.

3. The method of claim 2 wherein storing comprises:
storing information about the search queries, the clickthroughs, and the page views of the user.

4. The method of claim 1 wherein providing user access comprises:
receiving an access request from the user;
displaying the user profile information to the user; and
receiving a user modification request from the user.

5. The method of claim 4 further comprising:
modifying user profile according to the user modification request.

6. An online information system comprising:
a user profile database to store a user profile; and
a user recommendation system to create the user profile based on user behavior on the online information system and to modify the user profile based on user modification requests.

7. A method for an online information system, the method comprising:
storing user profiles which are based on user behavior on the user information system;
providing to a user a web page showing user interests as stored in the user profile; and
in response, receiving a user profile modification request.

8. The method of claim 7 wherein receiving the user profile modification request comprises:
receiving a request to clear all user interests from the user profile.

9. The method of claim 7 wherein receiving the user profile modification request comprises:
receiving a request to selectively clear specified user interests from the user profile.

10. The method of claim 7 wherein providing the web page comprises:
providing a list of interest topics each having an associated check box;
receiving information defining which check boxes have been checked by the user; and
updating the user profile to add interest topics associated with the boxes that have been checked by the user.

11. The method of claim 7 further comprising:
displaying qualitative user interest information; and
receiving qualitative interest modifications from the user.

12. The method of claim 11 wherein displaying qualitative user interest information comprises displaying each user interest with associated values of high, medium and low.

13. The method of claim 11 further comprising:
converting the qualitative interest modifications to quantitative information; and
updating the user profile using the quantitative information.

14. The method of claim 7 wherein receiving a user profile modification request comprises:
receiving information about which specific user interests of the user profile are to be modified; and
receiving an indication that modifications are final and no future modifications are to be made.

15. The method of claim 7 wherein receiving a user profile modification request comprises:
receiving information about which specific user interests of the user profile are to be modified; and
receiving an indication that modifications are to remain in effect until manually changed by the user.

16. The method of claim 7 wherein receiving a user profile modification request comprises:
receiving information about which specific user interests of the user profile are to be modified; and
receiving an indication that modifications may be subsequently changed either manually by the user or automatically upon further user behavior on the online information system.
